(19) United States
(12) Patent Application Publication
(10) Pub. No.: US 2008/0100585 A1
(43) Pub. Date: May 1, 2008

(54) MOBILE COMMUNICATION TERMINAL

(76) Inventor: Teemu POHJOLA, Helsinki (FI)

Correspondence Address: PERMAN & GREEN, 425 POST ROAD, FAIRFIELD, CT, 06824, US

(21) Appl. No.: 11/555,487

(22) Filed: Nov. 1, 2006

(51) Int. Cl. G06F 3/041

(52) U.S. Cl. 345/173

(57) ABSTRACT

A method for controlling selection of list items displayed in a list element having one user operation mode on a touch sensitive display of an apparatus further including a controller, the touch sensitive display being configured to detect user input actions via a writing tool, the method includes detecting a first user input on the touch sensitive display, the first user input indicating a first selection of list items of the list element; selecting the first selection of list items; detecting a second user input on the touch sensitive display, the second user input indicating a second selection of at least one list item being distinct from the first selection of list items while the first selection is to remain selected; and selecting the second selection of at least one list item while the first selection of list items remains selected. A method is thus provided allowing the user to indicate a selection of a two separate selections of list items, only using the writing tool on the touch sensitive display. Corresponding apparatus and computer program product are also presented.

### FIELD

The disclosed embodiments generally relate to electronic equipment having a user interface with a touch sensitive display, and more particularly to a method for list item selection in an electronic apparatus having a user interface with a touch sensitive display.

### BACKGROUND

Presenting information as lists is one of the most common methods for arranging information in a logical manner for humans. This presentation format is widely used in various forms in various contexts, but especially in the computing world, vertical lists play an integral part. For example, items in the menus, or files in the folders have been traditionally presented as vertical list of individual items, opposed, for example, to the option of displaying the items in one horizontally expanding line.

Selection of list items from the list can be generally divided in to two categories: single selection and multiple selections. In single selection, the user can select only one list item at the time, and perform desired interactions to that one specific list item. In multiple selection, the user can select multiple list items from the list, and perform interactions to all of the selected items. In multiple selection, the user can most commonly select list item continuously, meaning that the list items between two user defined list items (for example the second list items to the fourth list item) are selected.

Another method for selecting multiple items from a list is to select them discontinuously. Discontinuous selection means that multiple list items can be selected without any relation to each other, where selection is commonly indicated using tick marks.

On desktop computer systems, a combination of continuous and discontinuous selection can be performed by combining a mouse and a keyboard. Continuous selection can be performed by a combination of mouse clicks and the shift key on the keyboard, and additional discontinuous selection is performed with the help of the mouse and a control key on the keyboard. While this works in the desktop world, for portable electronic apparatuses with a touch sensitive screen, it is desired to be able to perform a combination of continuous and discontinuous selection using only a stylus on the touch sensitive screen.

Consequently, there is a need for an improved method and apparatus addressing the problems discussed above.

### SUMMARY

In view of the above, it would be advantageous to solve or at least reduce the problems discussed above.

A first aspect of the disclosed embodiments include a method for controlling selection of list items displayed in a list element having one user operation mode on a touch sensitive display of an apparatus further comprising a controller, the touch sensitive display being configured to detect user input actions via a writing tool, the method comprising: detecting a first user input on the touch sensitive display, the first user input indicating a first selection of list items of the list element; selecting the first selection of list items; detecting a second user input on the touch sensitive display, the second user input indicating a second selection of at least one list item being distinct from the first selection of list items while the first selection is to remain selected; and selecting the second selection of at least one list item while the first selection of list items remains selected. A method is thus provided allowing the user to indicate a selection of a two separate selections of list items, only using

The detecting a second user input may further involve: detecting a tap in a position corresponding to a first list item of the second selection and a movement to a position corresponding to second list item of the second selection.

The detecting a second user input may further involve: detecting a tap in a position corresponding to a first list item of the second selection, a movement to a position being distinct from any position corresponding to the first list item of the second selection, and a lift in a position corresponding to the first list item of the second selection, the second selection of at least one list item consisting of the first list item of the second selection.

The detecting a first user input may further involve: detecting a tap in a position corresponding to a first list item of the first selection and a lift in a position corresponding to a second list item of the first selection.

The detecting a second user input and the selecting the second selection may be repeated for at least a second set of at least one list items.

The method may further comprise: detecting a third user input on the touch sensitive display, the third user input comprising a tap and a lift in a position corresponding to a previously unselected list item, and as a response to the third user input selecting the previously unselected list item and deselecting any previously selected list items.

A second aspect of the disclosed embodiments includes an apparatus comprising a controller, a touch sensitive display, and a writing tool configured for use with the touch sensitive display, the controller being configured to display a list element of list items on the touch sensitive display, the list element having one user operation mode, the controller is configured to detect a first user input on the touch sensitive display, the first user input indicating a first selection of list configured to, as a response to the first user input, select the first selection of list items; the controller is further configured to, after the selection, detect a second user input on the touch sensitive display, the second user input indicating a second selection of at least one list item being distinct from the first selection of list items while the first selection is to remain selected; the controller is further configured to, as a response to the second user input, select the second selection of at least one list item while the first selection of list items remains selected.

The controller may be further configured to detect a second user input on the touch sensitive display, the second user input comprising a tap in a position corresponding to a first list item of the second selection and a movement to a position corresponding to second list item of the second selection.

The apparatus may be comprised in a pocket computer.

A third aspect of the disclosed embodiment s includes an apparatus comprising: a controller, a touch sensitive display showing a list element with a plurality of list items, a writing tool, means for detecting a first user input on the touch sensitive display, the first user input indicating a first selection of list items of the list element; means for, as a response to the first user input, selecting the first selection of list items; means detecting a second user input on the touch sensitive display, the second user input indicating a second selection of at least one list item being first selection is to remain selected; and means for, as a response to the second user input, selecting the second selection of at least one list item while the first selection of list items remains selected.

A fourth aspect of the disclosed embodiments includes a computer program product comprising software instructions that, when executed in an electronic apparatus, performs the method according to the first aspect.

Other features and advantages of the present invention will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments of the claimed invention will now be described in more detail, reference being made to the enclosed drawings.

FIG. 1 is a perspective view of an electronic apparatus according to one embodiment, in the form of a pocket computer which is shown in a typical operating position in the hands of a user.

FIGS. 2 and 3 are different perspective views of the pocket computer of FIG. 1.

FIG. 4 illustrates a computer network environment in which the pocket computer of FIGS. 1-3 advantageously may be used for providing wireless access for the user to network resources and remote services.

FIG. 5 is a schematic block diagram of the pocket computer according to the previous drawings.

FIG. 6 is a flowchart diagram illustrating the execution of the pocket computer according to the previous drawings for list item selection.

FIGS. 7A to 7C are schematic screen views illustrating the method of FIG. 6.

### DETAILED DESCRIPTION

The disclosed embodiments now will be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

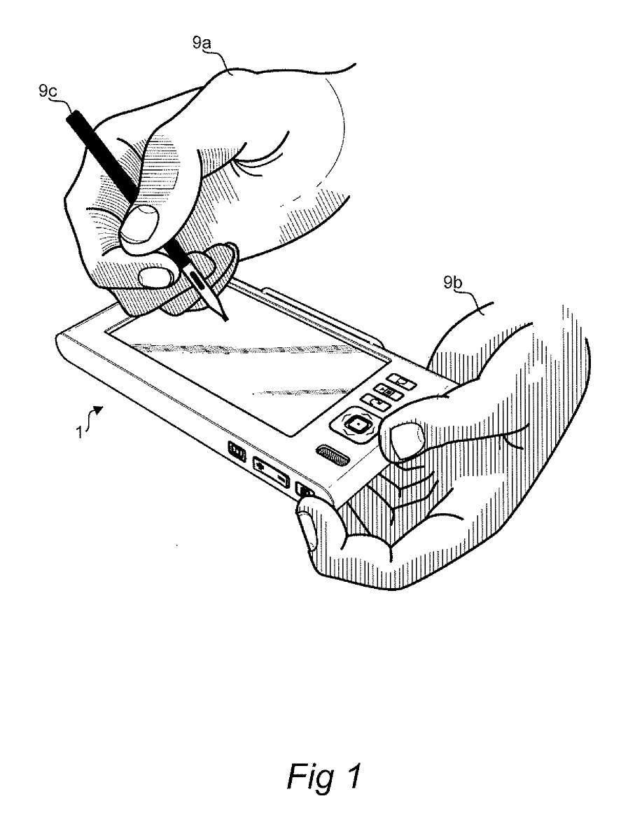

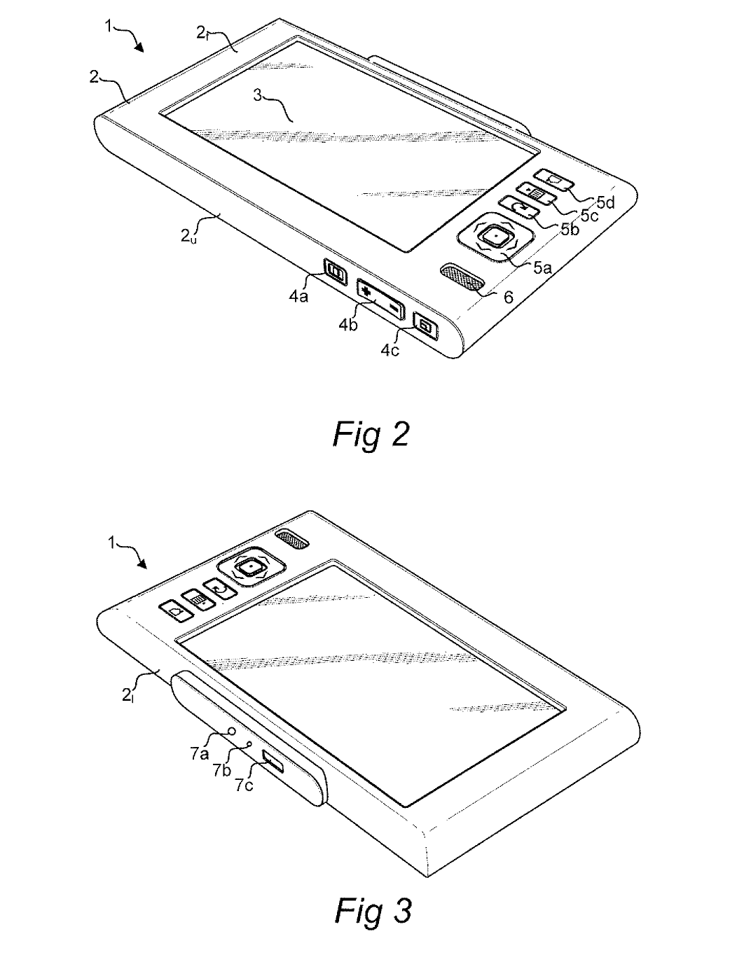

With reference to FIGS. 1 to 3, an electronic apparatus according to an embodiment of the present invention will now be described. The pocket computer 1 of the illustrated embodiment comprises an apparatus housing 2 and a relatively large touch-sensitive display screen 3 provided at a front side 2f of the apparatus housing 2. Next to the display screen 3 a plurality of hardware keys 5a-d are provided, as well as a speaker 6.

More particularly, key 5a is a five-way navigation key, i.e. a key which is depressible at four different peripheral positions to command navigation in respective orthogonal directions (“up”, “down”, “left”, “right”) among information shown on the display screen 3, as well as depressible at a center position to command selection among information shown on the display screen 3. Key 5b is a cancel key, key 5c is a menu or options key, and key 5d is a home key.

In addition, a second plurality of hardware keys 4a-c are provided at a first short side 2u of the apparatus housing 2. Key 4a is a power on/off key, key 4b is an increase/decrease key, and key 4c is for toggling between full-screen and normal presentation on the display screen 3.

At a second short side 21 of the apparatus housing 2, opposite to said first short side 2u, there are provided an earphone audio terminal 7a, a mains power terminal 7b and a wire-based data interface 7c in the form of a USB port.

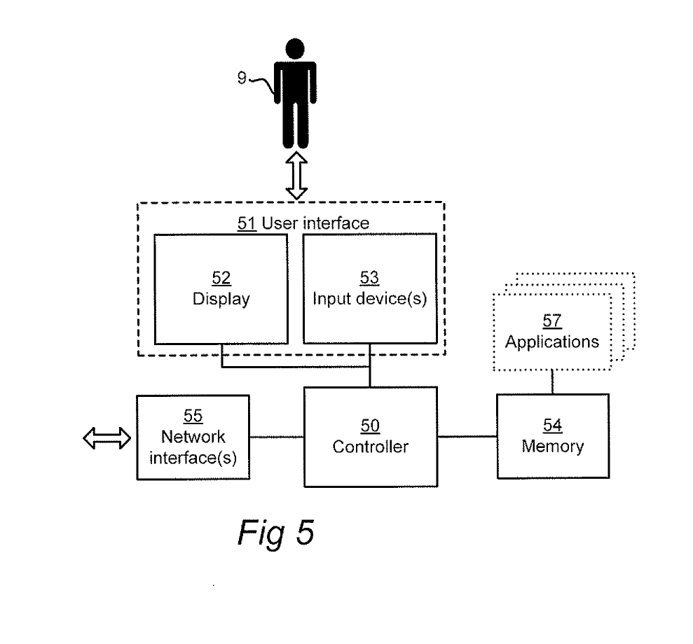

Being touch-sensitive, the display screen 3 will act both as a visual output device 52 and as an input device 53, both of which are included in a user interface 51 to a user 9 (see FIG. 5). More specifically, as seen in FIG. 1, the user 9 may operate the pocket computer 1 by pointing/tapping/dragging with a pointer 9c, also known as writing tool, such as a stylus or pen, held in one hand 9a, on the surface of the touch-sensitive display screen 3 and/or by actuating any of the hardware keys 4a-c, 5a-d (which also are included as input devices in the user interface 51) with the thumb and index finger of the other hand 9b. It is to be noted that a finger of the user may also be used as a pointer. In addition to this, the user interface may include other text input means, such as a virtual keyboard module and/or a handwriting input module with a handwriting recognition engine, both using inputs from the touch sensitive display.

As seen in FIG. 5, the pocket computer 1 also has a controller 50 with associated memory 54. The controller is responsible for the overall operation of the pocket computer 1 and may be implemented by any commercially available CPU (Central Processing Unit), DSP (Digital Signal Processor) or any other electronic programmable logic device. The associated memory 54 may be internal and/or external to the controller 50 and may be RAM memory, ROM memory, EEPROM memory, flash memory, hard disk, optical storage or any combination thereof. The memory 54 is used for various purposes by the controller 50, one of them being for storing data and program instructions for various pieces of software in the pocket computer 1. The software may include a real-time operating system, drivers e.g. for the user interface 51, as well as various applications 57.

The applications can be any suitable application, for example, but not limited to, a web browser, a messaging application (e.g. SMS, MMS, email), an instant messaging application, a network radio application, a media player, a contacts application, a word processing application, one or more electronic games, etc.

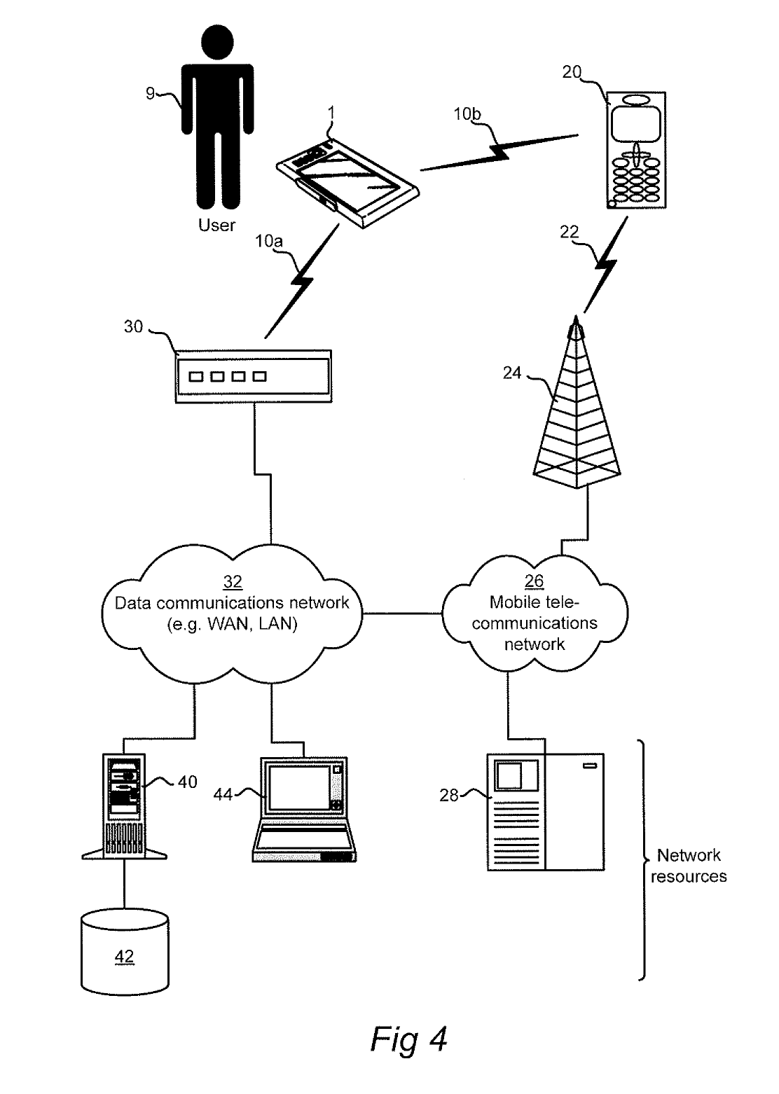

To allow portable use, the pocket computer 1 has a rechargeable battery. The pocket computer also has at least one interface 55 for wireless access to network resources on at least one digital network. More detailed examples of this are given in FIG. 4. Here, the pocket computer 1 may connect to a data communications network 32 by establishing a wireless link via a network access point 30, such as a WLAN (Wireless Local Area Network) router. The data communications network 32 may be a wide area network (WAN), such as Internet or some part thereof, a local area network (LAN), etc. A plurality of network resources 40-44 may be connected to the data communications network 32 and are thus made available to the user 9 through the pocket computer 1. For instance, the network resources may include servers 40 with associated contents 42 such as www data, wap data, ftp data, email data, audio data, video data, etc. The network resources may also include other end-user devices 44, such as personal computers.

A second digital network 26 is shown in FIG. 4 in the form of a mobile telecommunications network, compliant with any available mobile telecommunications standard such as GSM, UMTS, D-AMPS or CDMA2000. In the illustrated exemplifying embodiment, the user 9 may access network resources 28 on the mobile telecommunications network 26 through the pocket computer 1 by establishing a wireless link 10b to a mobile terminal 20, which in turn has operative access to the mobile telecommunications network 26 over a wireless link 22 to a base station 24, as is well known per se. The wireless links 10a, 10b may for instance be in compliance with Bluetooth™, WLAN (Wireless Local Area Network, e.g. as specified in IEEE 802.11), HomeRF, WiMAX or HIPERLAN. Thus, the interface(s) 55 will contain all the necessary hardware and software required for establishing such links, as is readily realized by a man skilled in the art.

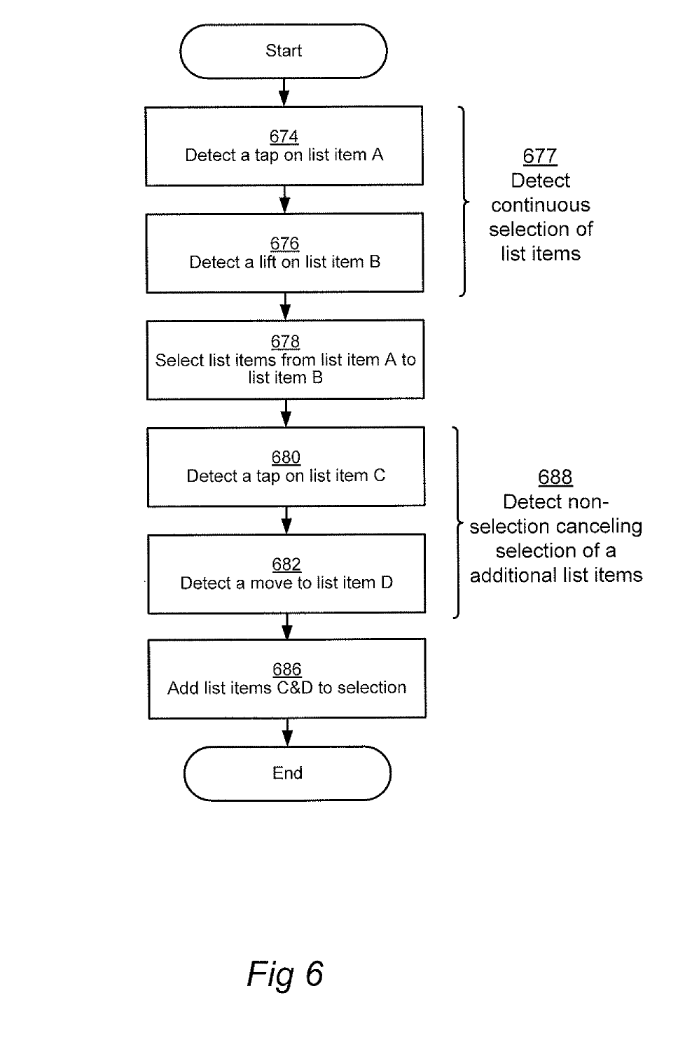

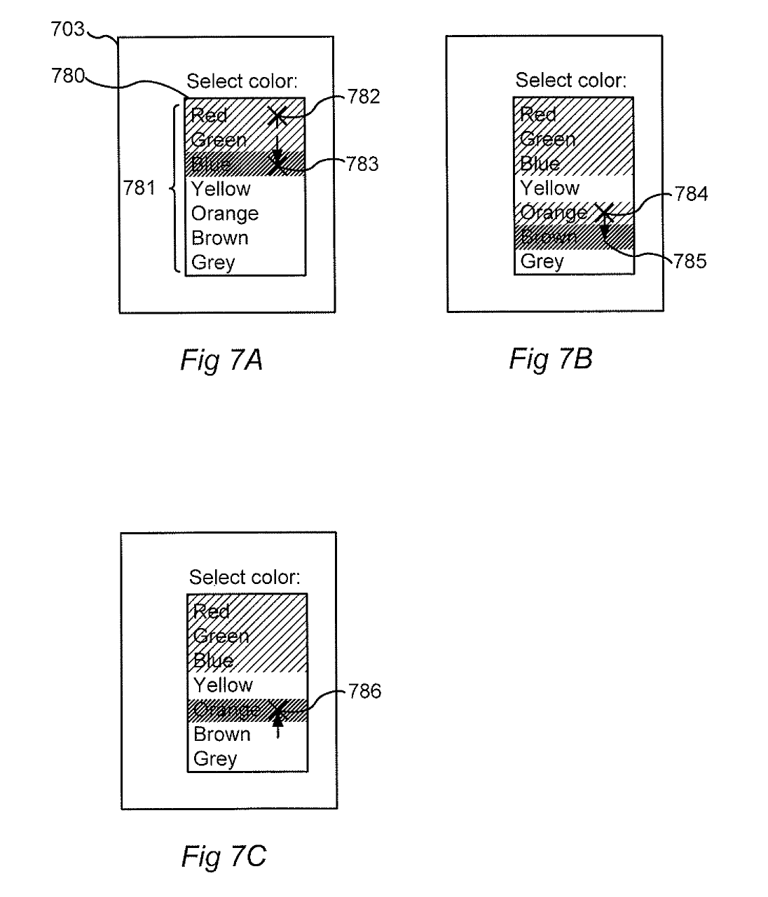

FIG. 6 is a flow chart illustrating a method of an embodiment. Refer to FIG. 7A-C for an illustrative graphical representation of the list element. The method provides the user with a user interface element representing a list with one user operation mode, henceforth called a list element. The flow chart illustrates the way in which selections of list items can be made. The method in this example is executing in the pocket computer 1 with its touch sensitive display 3.

In a detect a tap on list item A step 674, a tap of the writing tool 9c is detected on the touch sensitive display 3 in a position corresponding to a list item A. List item A can be any list item visible in the list element on the touch sensitive display 3.

In a detect a lift on list item B step 676, a lift is detected, where the last recorded position of the writing tool 9c on the touch sensitive display 3 was in a position corresponding to a list item B. List item B can be any list item visible in the list element on the touch list item A to the lift on list item B, the user has dragged the writing tool 9c, not lifting the writing tool 9c until the writing tool 9c is on list item B.

The combination of the steps: detect a tap on list item A 674 and detect a lift on list item B 676, can be seen as a step 677 to detect continuous selection of list items.

In a select list items from list item A to list item B step 678, the pocket computer responds to the previous input and selects all list items geometrically from list item A to list item B, creating a continuous selection (including list item A and list item B).

In a detect tap on list item C step 680, a tap of the writing tool 9c is detected on the touch sensitive display 3 in a position corresponding to a list item C. List item C can be any list item visible in the list element on the touch sensitive display 3 that is not previously selected.

In a detect move to list item D step 682, a move of the writing tool 9c is detected, the position of the writing tool 9c now corresponding to a list item D. The writing tool has not been lifted since the tap on list item C.

The combination of the steps: detect a tap on list item C 680 and detect a move to list item D 682, can be seen as a step 688 to detect non-selection canceling selection of additional list items. In other words, the additional list items, in this case C and D, are to be added to the selection without deselecting any previously selected list items. It is to be noted that if the user, after having moved the writing tool 9c to item D, moves the writing tool back to item C without lifting the writing tool, only item C is added to the selection.

In an add list items C and D to selection step 686, the list items C and D are added to the selection, without deselecting any previously selected list items.

After lifting the writing tool, the Steps 680 to 686 can be repeated an arbitrary number of times to allow the user to add additional list items to the selection.

This method thus provides a novel way of allowing a user to select both continuous and discontinuous list items using only a writing tool 9c on a touch sensitive display 3.

FIGS. 7A to 7C are schematic screen views illustrating the method for list item selection of FIG. 6.

In FIG. 7A, a screen 703 shown on the touch sensitive display 3 shows a list element with one user operation mode in the form of a list box 780. One user operation mode means that the user can not change the operation of the list box, for example from single selection mode to a multiple selection mode; the list box has one user operation mode for both single and multiple selections, as described below. The list box 780 contains a number of different list items 781, each item representing a color that the user can select. The user performs a tap of the writing tool 9c in a position 782, corresponding to the list item ‘red’, and drags the writing tool to a position 783, where the writing tool 9c is lifted. The position 783 corresponds to a list item ‘blue’. The tap, drag and lift is interpreted by the pocket computer 1 as a continuous selection, whereby all items from ‘red’ to ‘blue’ are selected, which in this case also included ‘green’. The most recently selected item ‘blue’ is indicated with a more intense shadowing.

In FIG. 7B, the user has performed a tap in a position 784 corresponding to a list item ‘orange’ and a drag to a position 785 corresponding to a list item ‘brown’. The writing tool is in this view still pressed down and has not been lifted, since the tap on ‘orange’.

In FIG. 7C, the user continues from FIG. 7B by dragging the writing tool 9c back to ‘orange’, where the user lifts the writing tool 9c in a position 786. The pocket computer 1 responds by adding ‘orange’ to the selection without deselecting any of the previously selected list items.

Note that if the user had lifted the writing tool in FIG. 7B, in position 785, it is still interpreted as an instruction to keep previous selections, whereby the new continuous selection of items ‘orange’ and ‘brown’ are selected along with the previously selected “red”, “green” and “blue”. On the other hand, had the user in Fib 7b only tapped and lifted the writing tool 9c (without significant movement) in position 784, only ‘orange’ would have been selected, deselecting any previously selected list items. This is to ensure that the user has a natural way of deselecting items, as well as selecting.

It is to be noted that while the invention has been exemplified using an pocket computer with a touch sensitive display, any type of user interface with a display and a positional input can be used, e.g. a computer screen and a mouse.

The invention has mainly been described above with reference to a few embodiments. However, as is readily appreciated by a person skilled in the art, other embodiments than the ones disclosed above are equally possible within the scope of the invention, as defined by the appended patent claims.

What is claimed is:

1. A method for controlling selection of list items displayed in a list element having one user operation mode on a touch sensitive display of an apparatus further comprising a controller, said touch sensitive display being configured to detect user input actions via a writing tool, said method comprising:
detecting a first user input on said touch sensitive display, said first user input indicating a first selection of list items of said list element;
selecting said first selection of list items;
detecting a second user input on said touch sensitive display, said second user input indicating a second selection of at least one list item being distinct from said first selection of list items while said first selection is to remain selected; and
selecting said second selection of at least one list item while said first selection of list items remains selected.

2. The method according to claim 1, wherein said detecting a second user input further involves:
detecting a tap in a position corresponding to a first list item of said second selection and a movement to a position corresponding to second list item of said second selection.

3. The method according to claim 1, wherein said detecting second user input further involves:
detecting a tap in a position corresponding to a first list item of said second selection, a movement to a position being distinct from any position corresponding to said first list item of said second selection, and a lift in a position corresponding to said first list item of said second selection, said second selection of at least one list item consisting of said first list item of said second selection.

4. The method according to claim 1, wherein said detecting a first user input further involves:
detecting a tap in a position corresponding to a first list item of said first selection and a lift in a position corresponding to a second list item of said first selection.

5. The method according to claim 1, wherein said detecting a second user input and said selecting said second selection are repeated for at least a second set of at least one list items.

6. The method according to claim 1, further comprising: detecting a third user input on said touch sensitive display, said third user input comprising a tap and a lift in a position corresponding to a previously unselected list item, and as a response to said third user input selecting said previously unselected list item and deselecting any previously selected list items.

7. An apparatus comprising a controller, a touch sensitive display, and a writing tool configured for use with said touch sensitive display,
said controller being configured to display a list element of list items on said touch sensitive display, said list element having one user operation mode,
said controller is configured to detect a first user input on said touch sensitive display, said first user input indicating a first selection of list items of said list element;
said controller is further configured to, as a response to said first user input, select said first selection of list items;
said controller is further configured to, after said selection, detect a second user input on said touch sensitive display, said second user input indicating a second selection of at least one list item being distinct from said first selection of list items while said first selection is to remain selected;
said controller is further configured to, as a selection of at least one list item while said first selection of list items remains selected.

8. The apparatus according to claim 7, wherein: said controller is further configured to detect a second user input on said touch sensitive display, said second user input comprising a tap in a position corresponding to a first list item of said second selection and a movement to a position corresponding to second list item of said second selection.

9. The apparatus according to claim 7, wherein said apparatus is comprised in a pocket computer.

10. An apparatus comprising:
a controller,
a touch sensitive display showing a list element with a plurality of list items,
a writing tool,
means for detecting a first user input on said touch sensitive display, said first user input indicating a first selection of list items of said list element;
means for, as a response to said first user input, selecting said first selection of list items;
means detecting a second user input on said touch sensitive display, said second user input indicating a second selection of at least one list item being distinct from said first selection of list items while said first selection is to remain selected; and
means for, as a response to said second user input, selecting said second selection of at least one list item while said first selection of list items remains selected.

11. A computer program product comprising software instructions that, when executed in an electronic apparatus, performs the method according to claim 1.
